(19) United States
(12) Patent Application Publication
(10) Pub. No.: US 2026/0270251 A1
(43) Pub. Date: Sep. 10, 2026

(54) METHODS AND SYSTEMS FOR MANAGING ACCESS TO A CLOUD PLATFORM

(71) Applicant: Y.E. Hub Armenia LLC, Yerevan (AM)

(72) Inventors: Vladislav ARKHIPOV, Moscow (RU); Arkadiy VYAZNIKOV, Moscow (RU); Anton DEDOV, Moscow (RU); Evgeny SIDOROV, Moscow (RU)

(21) Appl. No.: 19/442,101

(22) Filed: Jan. 7, 2026

(30) Foreign Application Priority Data
Mar. 5, 2025 (RU) 2025105094

(51) Int. Cl. H04L 9/40

(52) U.S. Cl. CPC H04L 63/0807; H04L 63/104; H04L 63/107; H04L 63/20

(57) ABSTRACT

Systems and methods are disclosed for access right management. The system includes a first resource group associated with a first operational parameter, the first resource group includes a first Identity Access Management (IAM) sub-system configured to manage access to the first resource group based on a plurality of first rules. The system also includes a second resource group associated with a second operational parameter, the second resource group includes: a second IAM sub-system configured to manage access to the second resource group based on a plurality of second rules. The first IAM sub-system is configured to provide access to the main tenant in first resource group based on a token received from the second resource group and which has been generated by the first IAM sub-system.

### CROSS-REFERENCE

The present application claims priority to Russian Patent Application No. 2025105094, entitled “Methods and Systems for Managing Access to a Cloud Platform”, filed Mar. 5, 2025 the entirety of which is incorporated herein by reference.

### FIELD

The present technology relates to access management in general, and more specifically, to methods and systems for managing access to a cloud platform.

### BACKGROUND

Cloud tenant management systems are employed for operating multi-tenant environments, where a shared infrastructure supports multiple independent tenants. These systems provide functionalities such as resource provisioning, tenant isolation, monitoring, and access control, ensuring secure and efficient use of shared resources. Tenant isolation is achieved through mechanisms like virtualized environments and access control policies, which protect each tenant's data and configurations from unauthorized access. Resource provisioning in conventional systems typically relies on static allocation models, which can lead to inefficiencies, such as under-utilization during low demand or performance bottlenecks during peak usage. Monitoring tools provide visibility into resource consumption and performance metrics, but conventional systems often lack the scalability and real-time responsiveness required for large and dynamic environments.

Identity and Access Management (IAM) systems are components of tenant management systems, providing authentication, authorization, and governance to secure tenant-specific resources. IAM systems handle user identities, roles, and permissions, ensuring that only authorized users can access sensitive data and services. Authentication is commonly implemented using methods like single sign-on (SSO), multifactor authentication (MFA), and federated identity protocols such as OAuth or SAML, which verify the identities of users and devices accessing the system. Authorization is often managed through role-based access control (RBAC), where predefined roles determine access privileges. In more advanced scenarios, attribute-based access control (ABAC) enables dynamic, context-aware permissions based on user attributes and environmental factors, offering greater flexibility but requiring more complex implementations.

IAM systems also manage user provisioning and lifecycle events, including creating, updating, and deactivating user accounts to align with tenant-specific policies. These processes often involve synchronizing identity data across multiple applications and services, which can become increasingly challenging as the number of tenants and their requirements grow. Monitoring and auditing capabilities in IAM systems provide visibility into user activity and policy enforcement, helping administrators detect anomalies and ensure compliance with security standards. However, conventional IAM systems may struggle with real-time analysis and correlation of security events across tenants, leaving gaps in threat detection and response.

Conventional systems often face challenges in scalability, adaptability, and integration. As cloud environments grow more complex, there is a pressing need for advanced systems that leverage automation, machine learning, and dynamic resource optimization to address these limitations, enhance performance, and meet evolving security demands.

US Patent application 2021/218572 discloses a storage method and system for the internet of things.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

At least some aspects of the present technology are directed to systems and methods for access rights management in cloud platforms and server-based computing solutions. These systems provide on-demand shared processing resources and data storage, often hosted in third-party data centers. Despite utilizing distributed data center loads, server-based solutions typically operate based on server resources located in specific regions, each governed by unique data protection and storage policies (e.g., different countries). Secure data sharing and distributed access rights control are desired when transferring data between centers.

Identity and Access Management (IAM) systems are a component in modern cloud platforms and are used for authenticating users and authorizing resource access, ensuring operations are performed only by authenticated and authorized users. Cloud platforms enable multi-regional resource access, allowing businesses to optimize server load allocation, allow for high availability, maintain continuity, and/or comply with region-specific security and data storage requirements.

It should be noted that one or more architectures and/or different operational logic of IAM sub-systems in multi-regional cloud platforms are contemplated. Developers have realized that a choice of IAM architecture may depend on inter alia specific requirements of the platform, including latency, regulatory compliance, fault tolerance, and/or administrative complexity.

In one embodiment, a control-plane IAM configuration may be employed. In this architecture, a given region is designated for centralized management of authentication, authorization, and/or access control policies across the platform. Other regions synchronize with the given region, relying on its access management operations. For example, Amazon™ Web Services (AWS™) utilizes a configuration where a central control-plane governs access rights across regions. This approach provides centralized governance and ensures consistent enforcement of policies. However, reliance on the given region for IAM operations may introduce latency for cross-regional communication and necessitate failover mechanisms to mitigate disruptions in the event of primary region failures.

In an other embodiment, independent regional IAM configurations may be employed.

In this architecture, each region operates its own IAM sub-system autonomously, enabling localized authentication and authorization mechanisms. For example, Google™ Cloud Platform (GCP) supports independent IAM sub-systems in each region. Independent regional IAM sub-systems reduce latency by handling requests locally and allow for region-specific policy implementations. This approach can be advantageous for compliance with local regulations and for applications requiring low-latency access. However, the decentralized nature of this architecture may introduce administrative complexity and necessitate mechanisms to ensure consistency across regions.

In a further embodiment, a hybrid IAM configuration may be employed. In this architecture, a centralized control-plane manages global policies while allowing regional overrides to address specific regulatory and/or operational needs. Additionally, synchronization between regional IAM sub-systems and the centralized control-plane may occur to maintain coherence while providing regional autonomy.

Developers have realized that there is a need for access management architectures in scenarios involving multi-regional organizations. Specifically, such organizations must account for the unique characteristics and regulatory requirements of each region. For example, a platform's architecture should provide security and/or privacy guarantees, including the ability to regulate access to resources in one region based on settings or policies defined in an other region.

In at least one embodiment of the present technology, there is disclosed a multi-region architecture for access rights management in which each region can operate as an independent instance of the platform, including an independent IAM sub-system. In some embodiments, such a multi-region architecture may establish an access rights management system utilizing a tenant-based rights-sharing logic. In other embodiments, such a multi-region architecture may enable a strictly unidirectional synchronization of access rights between regions. More particularly, access rights granted to a tenant in a main region may be synchronized to an associated region, but not vice versa. Developers have realized that such a multi-region architecture may reduce the risk of data leakage in the event of tenant compromise.

In at least one embodiment of the present technology, there is disclosed a multi-region architecture for access rights management for increasing data security by ensuring that a data breach, sometimes referred to as “token leak”, in one region does not affect data security in other regions. For example, if resources created in one region are compromised, such a multi-region architecture may prevent resources created in an other region to also be compromised. It can be said that such a multi-region infrastructure may aid in limiting effects of a data breach in a specific region to be localized, thereby enhancing overall system security and/or compliance.

In a first broad aspect of the present technology, there is provided a system comprising a first resource group associated with a first operational parameter, the first resource group including: a first Identity Access Management (IAM) sub-system configured to manage access to the first resource group based on a plurality of first rules; a first service account configured to create main tenants in the first resource group; a first main tenant created in response to a user request, access to the main tenant being managed via at least one first rule amongst the plurality of first rules; a second resource group associated with a second operational parameter, the second resource group including: a second IAM sub-system configured to manage access to the second resource group based on a plurality of second rules; a linked service account associated with the first service account and configured to create linked tenants in the second resource group; a linked tenant created by the linked service account, the linked tenant being associated with the main tenant, access to the first linked tenant being managed via at least one second rule amongst the plurality of second rules; and wherein the first IAM sub-system is configured to provide access to the main tenant in first resource group based on a token received from the second resource group and which has been generated by the first IAM sub-system.

In some embodiments of the system, the first operational parameter is indicative of a first geographical region and the second operational parameter is indicative of a second geographical region.

In some embodiments of the system, the first service account is configured to synchronize at least one administrative entity from the main tenant with the linked tenant.

In some embodiments of the system, the at least one administrative entity is at least one of a tenant user, a user group, and a tenant-level user access permission.

In some embodiments of the system, the first IAM sub-system and the second IAM sub-system are configured to generate access tokens and ID tokens.

In some embodiments of the system, the first IAM sub-system is configured to accept only access tokens generated by the first IAM sub-system.

In some embodiments of the system, the second IAM sub-system is configured to accept only access tokens generated by the second IAM sub-system.

In some embodiments of the system, the first IAM sub-system is configured not to provide access to the main tenant in first resource group based on a token received from the second resource group and which has not been generated by the first IAM sub-system.

In a second broad aspect of the present technology, there is provided a method executable by a system, the method comprising: generating a plurality of first access management rules for a first Identity Access Management (IAM) sub-system of the first resource group; creating a linked service account in a second resource group of the system for representing the first service account in the second resource group; creating, using the linked service account in the second resource group, a linked tenant in the second resource group, access to the linked tenant being managed via at least one second rule amongst a plurality of second rules of a second sub-system of the second resource group; granting, by the first IAM sub-system using at least one first rule amongst the plurality of access management rules, access to a main tenant in the first resource group in response to receiving a token from the second resource group that has been generated by the first IAM sub-system.

In some embodiments of the method, the method further comprises creating the main tenant in the first resource group in response to a user request.

In some embodiments of the method, the method further comprises prohibiting, by the first IAM sub-system using the at least one first rule, access to the main tenant in the first resource group in response to receiving an other token from the second resource group that has not been generated by the first IAM sub-system.

In some embodiments of the method, the method further comprises granting access for the linked service account to create linked tenants in the second region.

In some embodiments of the method, the first operational parameter is indicative of a first geographical region and the second operational parameter is indicative of a second geographical region.

In some embodiments of the method, the method further comprises synchronizing, by the first service account, at least one administrative entity from the main tenant with the linked tenant.

In some embodiments of the method, the at least one administrative entity is at least one of a tenant user, a user group, and a tenant-level user access permission.

In some embodiments of the method, the method further comprises generating access tokens and ID tokens by the first IAM sub-system and the second IAM sub-system.

In some embodiments of the method, the method further comprises accepting, by the first IAM sub-system, only access tokens generated by the first IAM sub-system.

In some embodiments of the method, the method further comprises accepting, by the second IAM sub-system, only access tokens generated by the second sub-system.

In the context of the present technology, a “tenant” is logically isolated entity within a cloud platform, created and managed by a client. A tenant functions as an administrative domain that organizes and governs the interactions between user accounts associated with the client organization and the resources provisioned within the tenant. A tenant administrator is authorized to manage access permissions for resources located within the tenant, ensuring secure and structured operations across the client's organization.

In the context of the present technology, a “main tenant” is a primary tenant entity instantiated by a client in a designated geographic region. This tenant acts as the authoritative directory and policy source, maintaining the canonical representation of user identities, roles, and access control policies for all secondary tenant instances across other regions associated with the client.

In the context of the present technology, “accesses” are a set of permissions assigned to a user or entity within a tenant, defining their operational privileges over cloud platform resources. These permissions can be scoped at the tenant level (applying globally to all resources within the tenant) or the resource level (applying specifically to designated resources). Accesses are configured by either a tenant administrator or a resource-specific administrator, depending on the scope of authority.

In the context of the present technology, an “administrator” is an authorized user with elevated privileges for managing access control policies and configurations within the cloud platform. A tenant administrator is responsible for managing permissions across the tenant's resources, while a resource-specific administrator has delegated authority to manage access to individual resources, such as a database instance or virtual machine.

In the context of the present technology, a “service account” is a non-human account type used for authentication and operational automation within the cloud platform. Service accounts are utilized by applications, workflows, or automation scripts to interact with cloud resources programmatically. These accounts are considered resources of the tenant, inheriting security and access policies scoped to their operational context.

In the context of the present technology, a “resource” is a discrete, consumable entity provided by the cloud platform, representing a functional unit that can be allocated, managed, and utilized by clients. Resources include infrastructure components such as virtual machines, managed database instances, serverless compute functions, storage buckets, and other services offered by the platform. Each resource is associated with specific configurations, metrics, and access control settings.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a computer system, in accordance with at least some non-limiting embodiments of the present technology.

FIG. 2 is a schematic representation of a networked system, in accordance with at least some non-limiting embodiments of the present technology.

FIG. 3 is a schematic representation of a first resource group in a first region and a second resource group in a second region, in accordance with at least some non-limiting embodiments of the present technology.

FIG. 4 is a schematic representation a token exchange mechanism supporting cross-regional interactions, in accordance with at least some non-limiting embodiments of the present technology.

FIG. 5 is a schematic representation of a process for creating a linked tenant across multiple regions, in accordance with at least some non-limiting embodiments of the present technology.

FIG. 6 is a scheme-block representation of a method executable by a computer system of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

With these fundamentals in place, we will now consider some non-limiting examples to illustrate various implementations of aspects of the present technology.

### Computer System

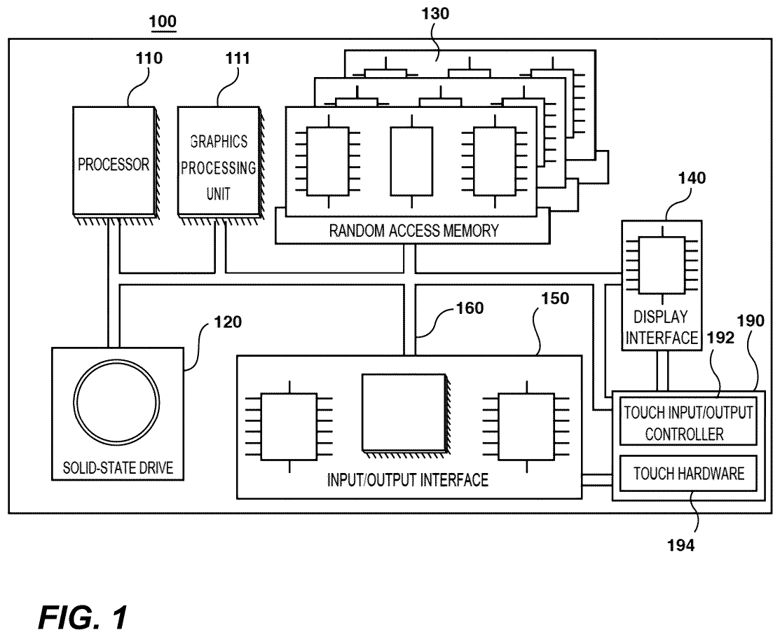

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library and/or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted that some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160. In some embodiments, the touch hardware 194 may comprise pressure-sensitive cells embedded in a layer of a display allowing detection of a physical interaction between a user and the display.

It should be noted that various implementations of the computer system 100 are contemplated. As it will become apparent from the description herein further below, one or more computer system connected over communication network may be implemented similarly to the computer system 100, without departing from the scope of the present technology.

### Networked Environment

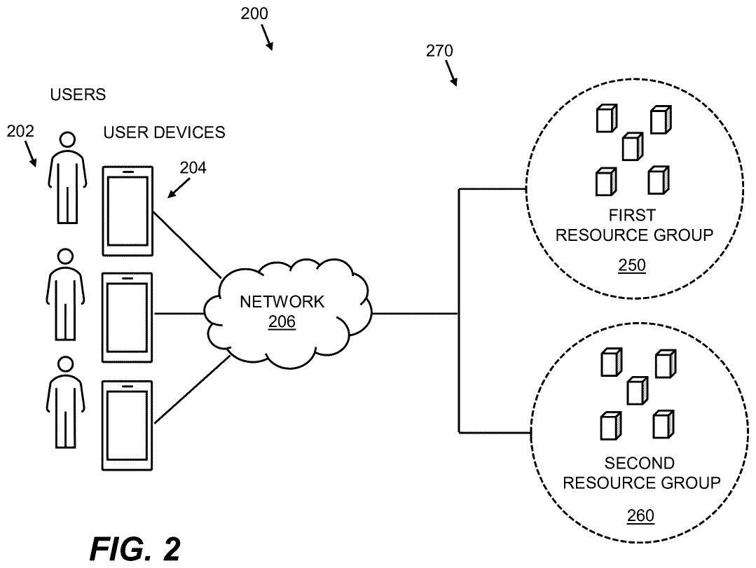

Referring to FIG. 2, there is shown a schematic diagram of a networked environment 200, the networked environment 200 being suitable for implementing non-limiting embodiments of the present technology. It is to be expressly understood that the networked environment 200 as depicted is merely an illustrative implementation of the present technology. Thus, the description thereof that follows is intended to be only a description of illustrative examples of the present technology.

Broadly speaking, the networked environment 200 is configured for providing access to resources in a multi-region cloud system 270. To that end, the networked environment 200 comprises inter alia a plurality of electronic devices 204 associated with users 202, a first resource group 250 of the multi-region cloud system 270, and a second resource group 260 of the multi-region cloud system 270. As it will become apparent from the description herein further below, the first resource group 250 may be located in a first geographical region, while the second resource group 260 may be located in a second, different, geographical region.

For example, a given user 202 via the electronic device 204 may desire to access resource in the first and/or the second resource group 250 and 260. Some functionality of components of the networked environment 200 will now be described in greater detail.

As mentioned above, the networked environment 200 comprises a plurality of electronic devices comprising the electronic device 204 associated with the user 202. As such, the electronic device 204, or simply “device” 204 can sometimes be referred to as a “client device”, “end user device” or “client electronic device”. It should be noted that the fact that the electronic device 204 is associated with the user 202 does not need to suggest or imply any mode of operation—such as a need to log in, a need to be registered, or the like.

In the context of the present specification, unless provided expressly otherwise, “electronic device” or “device” is any computer hardware that is capable of running a software appropriate to the relevant task at hand. Thus, some non-limiting examples of the device 204 include personal computers (desktops, laptops, netbooks, etc.), smartphones, tablets and the like. The device 204 comprises hardware and/or software and/or firmware (or a combination thereof), as is known in the art, to execute an application for accessing the multi-region cloud system 270.

Returning to the description of FIG. 2, the networked environment 200 comprises the communication network 206. In one non-limiting example, the communication network 206 may be implemented as the Internet. In other non-limiting examples, the communication network 206 may be implemented differently, such as any wide-area communication network, local-area communication network, a private communication network and the like. In fact, how the communication network 206 is implemented is not limiting and will depend on inter alia how other components of the networked environment 200 are implemented.

The purpose of the communication network 206 is to communicatively couple at least some of the components of the networked environment 200 such as the device 204, and a given resource in the first resource group 250 and the second resource group. For example, this means that the multi-region cloud system 270 is accessible via the communication network 206 by the device 204.

The communication network 206 may be used in order to transmit data packets amongst the device 204, and the multi-region cloud system 270. For example, the communication network 206 may be used to transmit data requests from the device 204 to the multi-region cloud system 270. In another example, the communication network 206 may be used to transmit the data responses from the multi-region cloud system 270 to the device 204.

The networked environment 200 comprises one or more servers configured to implement the first resource group 250 and the second resource group 260. The one or more servers may be implemented as conventional computer servers. In an example of an embodiment of the present technology, the one or more servers may be implemented as a Dell™ PowerEdge™ Server running the Microsoft™ Windows Server™ operating system. Needless to say, the one or more servers may be implemented in any other suitable hardware and/or software and/or firmware or a combination thereof. It should be noted that the functionality of the first resource group 250 and/or the second resource group may be distributed and may be implemented via multiple servers.

In at least some non-limiting embodiments of the present technology, there is provided a multi-region cloud system architecture in which a given region operates as a separate portion of the multi-region cloud system 270. For example, each regional portion (e.g., the first resource group 250 and the second resource group 260) may be deployed in a distinct country and/or jurisdiction to comply with specific regulatory requirements.

In this architecture, regions are configured to allow IAM users from one region to connect to IAM sub-systems in other regions using a variety of protocols. In one non-limiting example of the present technology, an OpenID Connect protocol may be employed. In some embodiments, by default, all client tenants can be confined to a region selected by the client during a tenant creation process.

A tenant administrator within the multi-region cloud system 270 may enable users within a given tenant in a given region to create and/or consume resources in an other region. For example, a linked tenant can be automatically generated in the other region and which serves as a representation, or “mapping”, of the main tenant in the other region. For example, a linked tenant in a second region may be a representation of a main tenant a first region.

The multi-region cloud system 270 may be configured to exchange information from the first resource group 250 to the second resource group 260, and/or vice versa. The type of information exchanged between the first and second resource groups 250 and 260 will become apparent from the description provided herein.

Administrative entities and/or relationships within the multi-region cloud system 270 can be synchronized from the main tenant to the linked tenant, including but not limited to, tenant users, user groups, and tenant-level user access permissions, without departing from the scope of the present technology.

It is contemplated that the extent and/or granularity of the synchronized data can be configured by the tenant administrator in a first region and/or in a second region. For example, an administrator in the first region may choose to synchronize only a limited subset of tenant user data and/or select specific users authorized to access resources in the second region.

The multi-region cloud system 270 may be configured so that administrative operations within the linked tenant are restricted. A plurality of administrative tasks can be initiated through an inter-regional synchronization process. For example, a tenant administrator may in a first region can assign resource-specific access permissions within a linked tenant in a second region, which will be managed solely by the IAM sub-system in the second region.

In some embodiments, “tenant-level” access can be assigned in a first region, while “resource-level” access can be assigned in a given region where the resource resides. It is contemplated that resource-specific access can be assigned cross-regionally depending on inter alia on a given access model being applied and/or various implementations of the present technology.

Developers of the present technology have realized that such an architecture for the multi-regional cloud platform 270 may allow for regulatory compliance, secure inter-regional operations. Developers of the present technology have also realized that such an architecture for the multi-regional cloud platform 270 may allow tenant administrators to manage access across regions while maintaining control over synchronized data and/or resource allocation.

With reference to Table 1 below, there is depicted a non-limiting example of configurations of a first region (R1) and of a second region (R2). In this non-limiting example, the first region R1 is a region with a main tenant, and the second region R2 is a region with a linked tenant (linked to the main tenant in the first region R1).

TABLE 1
Rights and tenants in one non-limiting example of
the first region R1 and of the second region R2

| | First region (R1) | Second region (R2) |
|---|---|---|
| Tenant | Main | Linked |
| Tenant- | Users | Users (copies) |
| embedded | User groups | User groups (copies) |
| entities | | |
| Resources | Tenant resources in R1 | Tenant resources in R2 |
| Accesses | Tenant-level accesses | Tenant-level accesses (copies) |
| | Resource-level accesses | Resource-level accesses |
| | for R1 | |

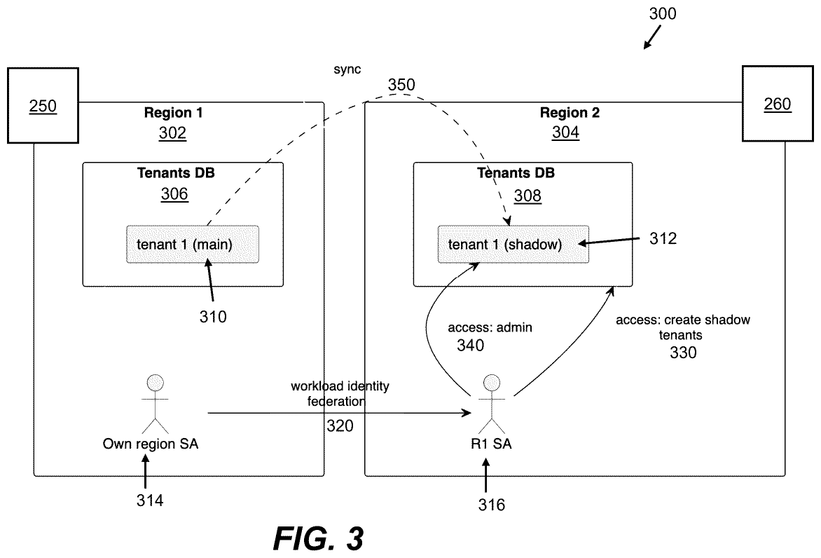

With reference to FIG. 3, there is depicted a linked tenant creation process 300 executable between the first resource group 250 in a first region 302 and the second resource group 260 in a second region 304. The first resource group 250 in the first region 302 may comprise a first tenant database 306 and the second resource group 260 in the second region 304 may comprise a second tenant database 308.

In at least some embodiments of the present technology, each of the first region 302 and the second region 304 may comprise a defined set of service accounts managed by a selected platform and that facilitates cross-regional interactions. Broadly speaking, a given set of service accounts for a given region may include, but is not limited to, a service account representing the region itself, and a subset of service accounts representing other regions (e.g., linked service accounts) with which the given region that have an established trust relationship. For example, the first resource group 250 of the first region 302 may include an “own region” service account 314 for operating in the first region 302. In another example, the second resource group 260 of the second region 304 may include a linked service account 316 that is (i) linked to the own region 314 in the first region 302, and (ii) for operating in the second region 304.

It should be noted that each service account representing a first given region may be granted permissions to create linked tenants within a second given region. For example, the linked service account 316 in the second region 304 may be granted permissions to create a linked tenant 312 within the second region 304. Upon creating the linked tenant 312, the linked service account 316 also may be granted access to manage the linked tenant 312. Management operations of the linked tenant may include, but is not limited to, creation of administrative entities required for synchronization by a main tenant 310 in the first region 302.

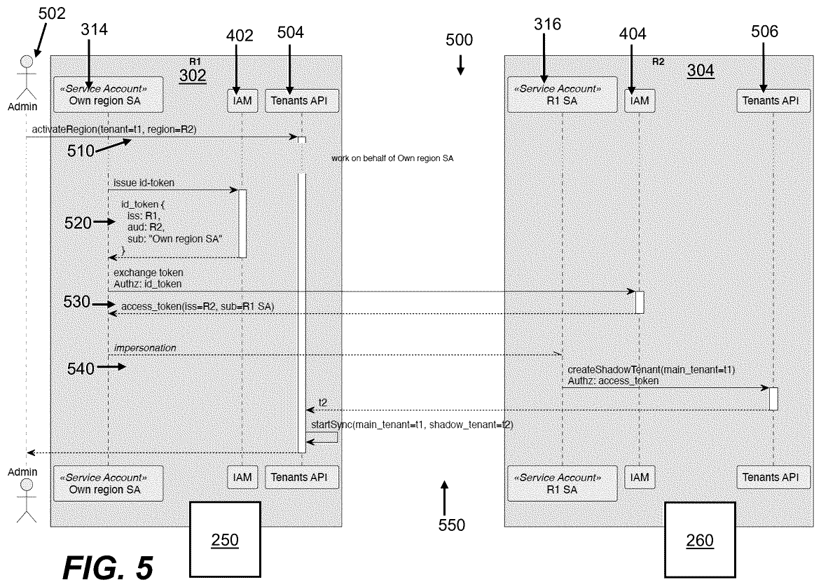

It is contemplated that one or more synchronization operations between regions may be initiated from a region hosting a main tenant. Such a multi-region cloud system architecture may provide a secure flow of data and/or operations between regions while maintaining limits and/or permissions for cross-regional interactions. How a synchronization operation 350 performed between the main tenant 310 in the first region 302 and the linked tenant 312 in the second region 304 will be described herein further below with reference to FIG. 5.

The multi-region cloud system 270 is configured to execute a token exchange process during interaction between the first resource group 250 in the first region 302 and the second resource group 260 in the second region 304. More particularly, a token of a given main service account from the first region may be exchanged for a token of a given linked service account in the second region. For example, a token of the first service account 314 from the first region 302 may be exchanged for a token of the linked service account 316 in the second region 304.

In some embodiments, the token exchange process may be executed by the multi-region cloud system 270 using Workload Identity Federation (WIF). To enable WIF, each region may establish a trust relationship between the identity of the first service account 314 from the first region 302 and the linked service account 316 in the second region 304. These trust relationships can be used for authenticating cross-regional interactions.

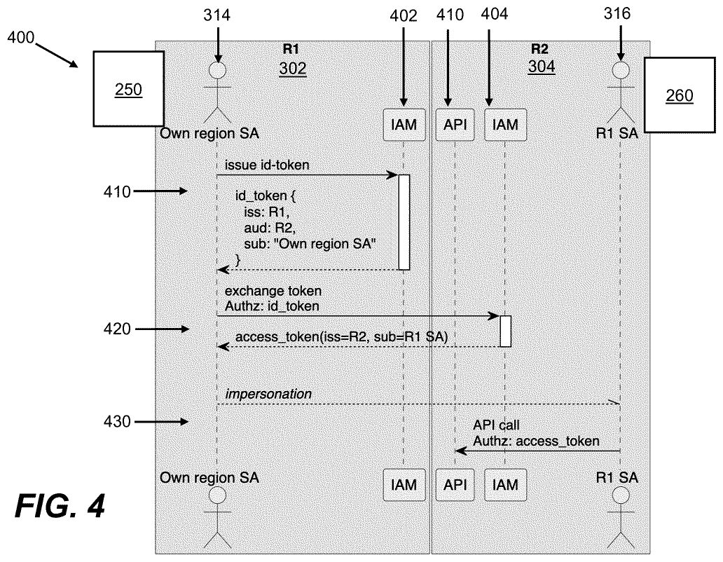

With reference to FIG. 4, there is illustrated a token exchange mechanism 400 supporting cross-regional interactions within the multi-region cloud system 270. The token exchange mechanism 400 can be executed for interactions between the first resource group 250 in the first region 302 and the second resource group 260 in the second region 304.

In some embodiments, cross-regional interactions can be designed to operate strictly in accordance with pre-defined scenarios. It is contemplated that the multi-region cloud system 270 may be configured so that different resources of the multi-region cloud system 270 do not interact across other regions at the API level. For example, the service account 314 does not communicate with an API 410 hosted in the second region 304.

Developers have realized that in some embodiments resources from different regions may allow control over interoperability of devices in different regions. In one non-limiting example, a memory device from a second region may be able to connect to a virtual machine in first region. At the architectural level, services deployed in regions may not be required to be “aware” of multi-regionality, which greatly simplifies the overall design. However, a service may implement some functionality with a focus on cross-region capabilities. To that end, the service can create an API that accounts for the region of the resource the user wants to utilize and build a corresponding token exchange procedure as described herein.

In at least some embodiments of the present technology, the multi-region cloud system 270 may enable a set of permissible interactions, which include, but not limited to: creation of linked tenants, synchronization between main and linked tenants, and specific pre-defined scenarios for interaction between resources located in different regions. It is contemplated that the set of permissible interactions may be defined and stored in a form of rules employed by IAM sub-systems in different regions within the multi-regional cloud platform 270.

It should be noted that each one of the first resource group 250 of the first region 302 and the second resource group 260 of the second region 304 comprise respective IAM sub-systems. For example, the first region 302 includes a first IAM sub-system 402 and the second region 304 includes a second IAM sub-system 404. The first and the second IAM sub-systems 402 and 404 are employed for managing authentication and/or authorization with the respective resource groups.

It should be noted that the first IAM sub-system 402 and/or the second IAM sub-system 404 may be configured to issue at least two types of tokens to users and/or service accounts. A first type of tokens includes “access” tokens that allow a user and/or a service account to invoke the cloud platform API 410 on behalf of a token holder. A second type of tokens includes “ID” tokens that serve as “proof” of user and/or service account authenticity. However, it should be noted that ID tokens cannot be used directly to access the cloud platform API 410.

It should be noted that a given IAM sub-system for a given region is configured to trust only the access tokens that same given IAM subsystem has issued. For example, the IAM sub-system 402 for the first region 302 is configured to trust only the access tokens that the IAM sub-system 402 has issued. As a result a given user and/or a given service account must obtain an access token issued by a given IAM sub-system of a given region during cross-regional interactions for performing one or more secured actions in the given region.

In one non-limiting embodiment of the present technology, the multi-region cloud system 270 may be configured to execute a server-to-server cross-regional interaction process according to the following steps. During a step 410, the first service account 314 of the first region 302 generates an ID token with the audience (aud) parameter provided by the IAM sub-system 402 for the second region 304. During a step 420, the ID token is exchanged for an access token belonging to the linked service account 316 in the second region 304. During a step 430, the obtained access token is used for API authorization in the second region 304.

With reference to FIG. 5, there is depicted an illustration of a process 500 for creating a linked tenant across multiple regions, followed by a synchronization process, to enable resource consumption in other regions. During a step 510, a linked tenant creation process is initiated. For example, an administrator 502 of the main tenant 310 may utilize a user interface (UI) and/or API of the first region 302 to initiate the process of creating a linked tenant in the second region 304. This process may be used to allow users within the administrative domain of the main tenant 310 to access and consume resources located in other regions, such as the second region 304.

During a step 520 and step 530, authorization and validation for interaction between the first resource group 250 and the second resource group 260 is performed. The step 520 and the step 530 may be executed similarly to how the step 410 and the step 420 of FIG. 4, respectively, are performed. During the step 540, authentication is performed, where the first service account 314 associated with the first region 302 is configured to request authentication with the linked service account representative 316 in the second region 304. The authentication request process allows to establish permissions and trust mechanisms for further actions. During a step 550, linked tenant creation and data synchronization are executed, during which the linked service account 316 in the second region 304 is configured to create the linked tenant 312 that is associated with the main tenant 310 of the first region 302. It should be noted that during step 550, a data synchronization process can be initiated to transfer and align data between the first region 302 and the second region 304, via tenants APIs 504 and 506 for example, thereby allowing functionality and interoperability for the linked tenant 312 in the second region 304.

It should be noted that the operation of creating a linked tenant can be initiated by an administrator. Then, after preliminary checks and authorization (i.e., to ensure the admin has the appropriate privileges), the system can create linked tenants on behalf of its own service accounts. It is contemplated that resource groups may be within tenants of different regions. In some embodiments, a resource group in a second region may be initiated after a tenant for it is created in the system.

Returning to the description of FIG. 3, a non-limiting example of a security threat scenario will now be described. In the scenario, let it be assumed that an adversary is an entity that gained unauthorized access privileges within a specific region. For example, the adversary may be a privileged insider of a given region and/or has access to compromised credentials of the administrator of the region. In this scenario, it can be said that the given region is compromised by the adversary. For example, in this scenario, the adversary may read and/or write on different resources of tenants within the compromised region, and/or issue tokens for different users and service accounts in the compromised region.

In some embodiments of the present technology, the multi-region cloud system 270 may may be configured to execute an access token isolation mechanism. It should be recalled that the first IAM sub-system 402 and the second IAM sub-system 404 of different regions do not accept each other's access tokens. For example, to interact with the API of the second region 304 on behalf of the first service account 314, the ID token of the first service account 314 from the first region 302 must be exchanged for an access token of the linked service account 316 in the second region 304, such as during a step 320 seen in FIG. 3.

It is contemplated that while implementing the non-limiting embodiments of the present technology, the token leakage in one region thus does not directly affect the security of other regions. For example, a region administrator can revoke trust with a specific region by prohibiting the exchange of ID tokens from a compromised region into access tokens for an other region. In some embodiments, token leakage may be mitigated by revoking trust.

It is contemplated that the linked service account 316 has restricted privileges in other regions (e.g., the first region 302). Linked service accounts in a current region have limited privileges via configuration of one or more IAM sub-systems in the current region and the other regions. For example, the linked service account 316 in the second region 304 may create new linked tenants, as shown by a step 330, and may administer linked tenants created in the second region 304, as shown by a step 340. However, the linked service account 316 does not have necessary privileges for executing one or more actions in the first region 302.

Developers of the present technology have devised an architecture for the multi-region cloud system 270 in which linked service accounts may not have administrative privileges across the multi-region cloud system 270. For example, the linked service account 316 cannot manage other tenants in the second region 304 and/or cannot manage tenants initially registered in region 304, and/or tenants created by main service accounts from other regions.

It is contemplated that the multi-region cloud system 270 may allow strict unidirectional data synchronization. Permissions granted to the main tenant 310 in the first region 302 can be synchronized to the linked tenant 312 in the second region 304, but not vice versa. As a result, a compromised region with a linked tenant impacts only the resources created within that compromised region, and the security of the main tenant and/or linked tenants in other regions may remain unaffected. For example, if the second region 304 with the linked tenant 312 is compromised, security of the main tenant 310 in the first region 302 and/or other linked tenants in the first region 302 and/or main and linked tenants in other regions in the multi-region cloud system 270 may remain unaffected.

It is contemplated that the multi-region cloud system 270 may allow administrator-controlled synchronization. The administrator of a main tenant can impose additional restrictions on inter-regional synchronization to comply with data security requirements and/or privacy requirements. For instance, synchronization may be limited to specific subsets of entities and/or permissions, without departing from the scope of the present technology.

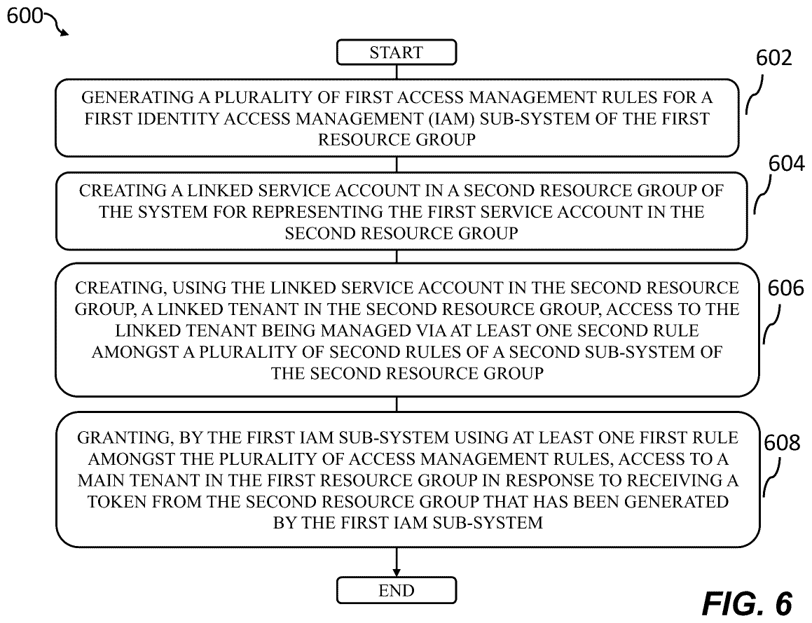

With reference to FIG. 6, there is depicted a scheme block representation of a method 600 executable by one or more processors implemented similarly to the processor 110 of FIG. 1. It is contemplated that one or more steps of the method 600 may be executed by a same processor and/or by more than one processor located in different locations (e.g., regions). Various steps of the method 600 will now be described in greater detail.

### Step 602: Generating a Plurality of First Access Management Rules for a First Identity Access Management (IAM) Sub-System Of the First Resource Group

The method 600 begins at step 602 with one or more processors configured to generate a plurality of first access management rules for a first Identity Access Management (IAM) sub-system of the first resource group.

It is contemplated that the IAM sub-system applies these rules to control access within the first resource group, ensuring that resource access is determined according to predefined rules.

In one non-limiting example, with reference to FIG. 6, IAM rules are established for first IAM sub-system 402 within the first resource group 250.

### Step 604: Creating a Linked Service Account in a Second Resource Group of the System for Representing the First Service Account In the Second Resource Group

The method 600 continues to step 604 with one or more processors configured to create a linked service account in a second resource group for representing the first service account in the second group.

It is contemplated that the linked service account enables communication between the first and second resource groups while maintaining security boundaries.

In one non-limiting example, with reference to FIG. 3, the linked service account 316 is created in the second resource group 260 of the second region 304. The linked service account 316 represents the first service account 314 of the first resource group 250.

Step 606: Creating, Using the Linked Service Account in the Second Resource Group, a Linked Tenant in the Second Resource Group, Access to the Linked Tenant being Managed Via at Least One Second Rule Amongst a Plurality of Second Rules of A Second Sub-System of the Second Resource Group

The method 600 continues to step 606 with one or more processors configured to create, using the linked service account in the second resource group, a linked tenant in the second resource group.

It is contemplated that access to the linked tenant is managed via at least one second rule amongst a plurality of second rules of a second IAM sub-system of the second resource group.

In one non-limiting example, with reference to FIG. 3, the linked tenant 312 is created using the linked service account 310 in the second resource group 260.

Step 608: Granting, by the First IAM Sub-System Using at Least One First Rule Amongst the Plurality of Access Management Rules, Access to a Main Tenant in the First Resource Group in Response To Receiving a Token from the Second Resource Group that has Been Generated by the First IAM Sub-System

The method 600 continues to step 608 with one or more processors configured to grant, by using the first IAM sub-system, access to the main tenant in the first resource group in response to receiving a token from the second resource group that has been generated by the first IAM sub-system.

It is contemplated that the first IAM sub-system enforces strict validation of received tokens to ensure they meet predefined security criteria before granting access.

In one non-limiting example, with reference to FIG. 4, the first IAM sub-system 402 is configured to grant access to the first tenant 310 in the first resource group 250 in response to receiving a valid token from the second resource group 260, provided that it has been generated by the first IAM sub-system 402.

It should be apparent to those skilled in the art that at least some embodiments of the present technology aim to expand a range of technical solutions for addressing a particular technical problem encountered by the conventional digital content item recommendation systems, namely selecting and providing for display digital content items that are relevant to the users.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A system comprising:
a first resource group associated with a first operational parameter, the first resource group including:
a first Identity Access Management (IAM) sub-system configured to manage access to the first resource group based on a plurality of first rules;
a first service account configured to create main tenants in the first resource group;
a first main tenant created in response to a user request, access to the main tenant being managed via at least one first rule amongst the plurality of first rules;
a second resource group associated with a second operational parameter, the second resource group including:
a second IAM sub-system configured to manage access to the second resource group based on a plurality of second rules;
a linked service account associated with the first service account and configured to create linked tenants in the second resource group;
a linked tenant created by the linked service account, the linked tenant being associated with the main tenant, access to the first linked tenant being managed via at least one second rule amongst the plurality of second rules;
and wherein the first IAM sub-system is configured to provide access to the main tenant in first resource group based on a token received from the second resource group and which has been generated by the first IAM sub-system.

2. The system of claim 1, wherein the first operational parameter is indicative of a first geographical region and the second operational parameter is indicative of a second geographical region.

3. The system of claim 1, wherein the first service account is configured to synchronize at least one administrative entity from the main tenant with the linked tenant.

4. The system of claim 3, wherein the at least one administrative entity is at least one of a tenant user, a user group, and a tenant-level user access permission.

5. The system of claim 1, wherein the first IAM sub-system and the second IAM sub-system are configured to generate access tokens and ID tokens.

6. The system of claim 5, wherein the first IAM sub-system is configured to accept only access tokens generated by the first IAM sub-system.

7. The system of claim 5, wherein the second IAM sub-system is configured to accept only access tokens generated by the second IAM sub-system.

8. The system of claim 1, wherein the first IAM sub-system is configured not to provide access to the main tenant in first resource group based on a token received from the second resource group and which has not been generated by the first IAM sub-system.

9. A method executable by a system, the method comprising:
generating a plurality of first access management rules for a first Identity Access Management (IAM) sub-system of the first resource group;
creating a linked service account in a second resource group of the system for representing the first service account in the second resource group;
creating, using the linked service account in the second resource group, a linked tenant in the second resource group,
access to the linked tenant being managed via at least one second rule amongst a plurality of second rules of a second sub-system of the second resource group;
granting, by the first IAM sub-system using at least one first rule amongst the plurality of access management rules, access to a main tenant in the first resource group in response to receiving a token from the second resource group that has been generated by the first IAM sub-system.

10. The method of claim 9, wherein the method further comprises creating the main tenant in the first resource group in response to a user request.

11. The method of claim 9, wherein the method further comprises prohibiting, by the first IAM sub-system using the at least one first rule, access to the main tenant in the first resource group in response to receiving an other token from the second resource group that has not been generated by the first IAM sub-system.

12. The method of claim 9, wherein the method further comprises granting access for the linked service account to create linked tenants in the second region.

13. The method of claim 9, wherein the first operational parameter is indicative of a first geographical region and the second operational parameter is indicative of a second geographical region.

14. The method of claim 9, wherein the method further comprises synchronizing, by the first service account, at least one administrative entity from the main tenant with the linked tenant.

15. The method of claim 14, wherein the at least one administrative entity is at least one of a tenant user, a user group, and a tenant-level user access permission.

16. The method of claim 9, wherein the method further comprises generating access tokens and ID tokens by the first IAM sub-system and the second IAM sub-system.

17. The method of claim 9, wherein the method further comprises accepting, by the first IAM sub-system, only access tokens generated by the first IAM sub-system.

18. The method of claim 9, wherein the method further comprises accepting, by the second IAM sub-system, only access tokens generated by the second sub-system.
